(19) United States
(12) Patent Application Publication
(10) Pub. No.: US 2025/0124662 A1
(43) Pub. Date: Apr. 17, 2025

(54) PREVENTING HARASSMENT ON METAVERSE ENVIRONMENTS

(71) Applicant: Kyndryl, Inc., New York, NY (US)

(72) Inventor: Cesar Augusto Rodriguez Bravo, Alajuela (CR)

(21) Appl. No.: 18/488,319

(22) Filed: Oct. 17, 2023

(51) Int. Cl. G06T 19/00; G06F 3/0484; H04L 9/40

(52) U.S. Cl. CPC G06T 19/003; G06F 3/0484; H04L 63/0421

(57) ABSTRACT

An approach is provided that displays avatars locating in a first virtual area to a first set of users with each user controlling one of the avatars. A request is received from one of the users to escape a situation. In response to the request, the system clones the user's first avatar thus creating a second avatar. The second avatar is visible to the user; however it is invisible to one or more of the set of users. The user controls the second avatar and the first avatar is automatically controlled using artificial intelligence (AI), with the user no longer controlling the first avatar.

### BACKGROUND

The Metaverse, a burgeoning digital realm encompassing virtual reality (VR), augmented reality (AR), and immersive technologies, is facing a pressing challenge: the prevention of harassment. In this dynamic landscape where users increasingly work, socialize, entertain, and learn, harassment takes on various forms, including verbal abuse, cyberbullying, stalking, and discrimination. These actions can severely impact the well-being of individuals and the overall inclusivity and safety of the Metaverse. As the Metaverse continues to evolve and draw more participants, addressing and mitigating harassment is becoming a paramount concern.

To create a safer Metaverse, it's essential to recognize the diverse forms that harassment can take, such as hate speech, offensive language, cyberbullying, and discrimination, and the significant consequences it can have on users' mental health and overall experience. This recognition underscores the importance of community guidelines, effective moderation systems, user-friendly reporting mechanisms, education, and legal frameworks to establish and maintain a respectful and inclusive digital environment for all users. By proactively tackling harassment, the Metaverse can realize its potential as a space for innovation, connection, and entertainment while ensuring the well-being and satisfaction of its diverse user base.

### SUMMARY

An approach is provided that displays avatars locating in a first virtual area to a first set of users with each user controlling one of the avatars. A request is received from one of the users to escape a situation. In response to the request, the system clones the user's first avatar thus creating a second avatar. The second avatar is visible to the user; however it is invisible to one or more of the set of users. The user controls the second avatar and the first avatar is automatically controlled using artificial intelligence (AI), with the user no longer controlling the first avatar.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting a disclosed approach of preventing harassment in a metaverse environment;

FIG. 4 is a flowchart depicting steps taken to set up a metaverse harassment prevention environment;

FIG. 5 is a flowchart depicting steps taken to allow a user to escape from a harassing situation in a metaverse environment; and

FIG. 6 is a flowchart depicting steps taken when cloning a user's avatar to allow the cloned avatar to escape from harassing users in an undetected fashion.

### DETAILED DESCRIPTION

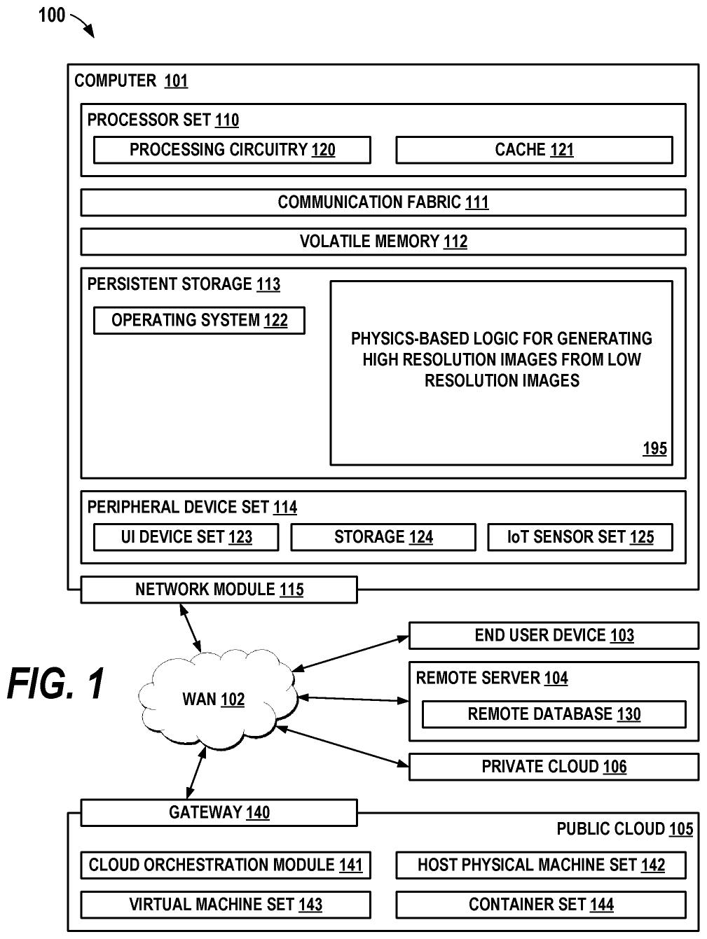

FIGS. 1-6 describe an approach that uses artificial intelligence (AI) to assist a user of a metaverse environment to escape a harassing or otherwise uncomfortable situation encountered by the user's avatar when interacting in the metaverse environment. The approach is designed to prevent such uncomfortable situations by discouraging “attackers” and other malevolent users found in the metaverse environment. The approach deceives the malevolent user into believing that the malevolent user is interacting with the user's avatar when, instead, the malevolent user is actually interacting with a system-controlled (e.g., AI, etc.) avatar while the user's actual avatar has escaped to a different area in the multiverse environment.

In one embodiment, the user can activate a “panic button” of sorts that notifies the virtual reality (VR) platform that the user is being harassed or is otherwise uncomfortable in the multiverse environment created by the VR platform. Once activated, the VR platform clones the user's avatar thus creating two avatars. However, only one of the avatars is visible to the malevolent users and the avatar visible to the malevolent users is controlled by the system, rather than the user. In one embodiment, the second avatar is invisible to the malevolent users and controlled by the user that activated the panic button. The user can use controls to move the new “invisible” avatar to a different area of the multiverse environment, ideally an area that is currently not visible by the malevolent users.

Once the user's new avatar is safely away from the malevolent users, it is made visible again so that other users in the multiverse environment can once again see the user's avatar. If other users become harassing, the user can again activate the “panic button” to create another clone and again escape from the harassing environment. Any number of clones of the user's avatar can be created to escape harassing or uncomfortable situations encountered in the multiverse environment.

In one embodiment, the avatar that is machine (AI) controlled that remains visible to the malevolent users uses voice and non-vocal models so that the machine-controlled avatar behaves and sounds like the user's avatar. However, since the system, rather than the user, is controlling this avatar, the user does not experience the harassment, attacks or other bad behavior directed to the avatar by the malevolent users.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

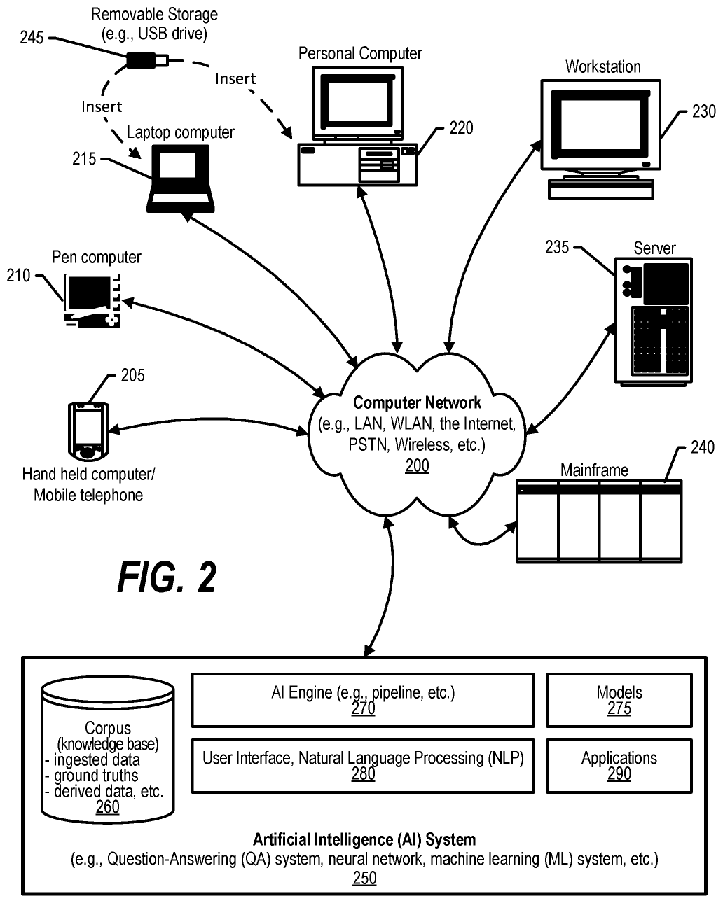

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users. Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

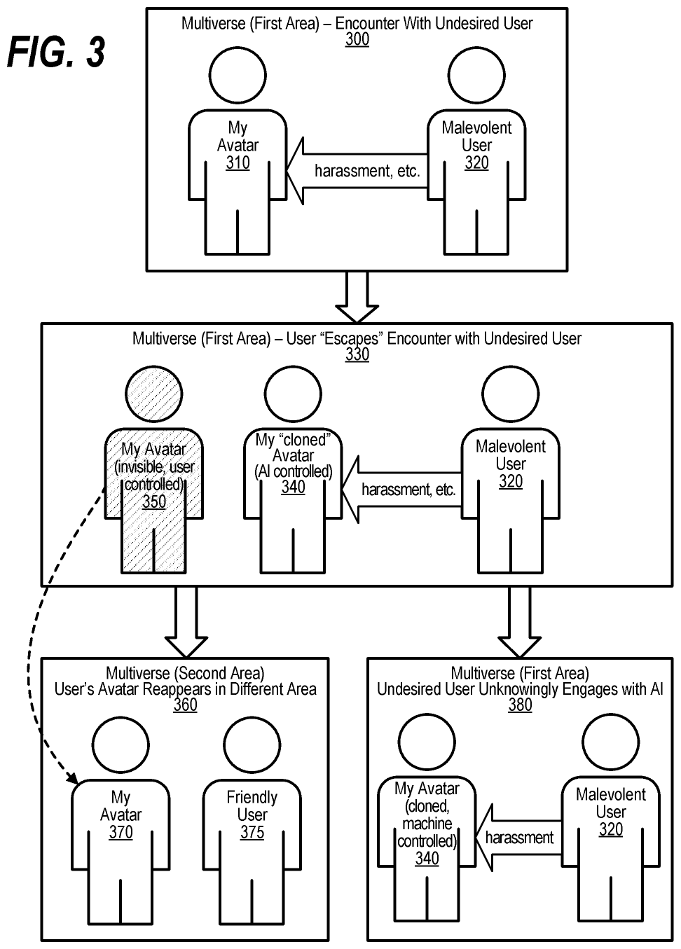

FIG. 3 is a diagram depicting a disclosed approach of preventing harassment in a metaverse environment. Block 300 depicts the user's avatar 310 having a harassing or otherwise uncomfortable encounter with malevolent user 320. The encounter can be any encounter that the user of avatar 310 feels is uncomfortable (e.g., verbal attack, lewd conduct towards avatar 310, virtual “physical” attack or altercation, etc.). The user of avatar 310 requests an “escape” (e.g., virtual “panic button,” etc.) with the request being received by the virtual reality (VR) platform on which the multiverse is operating.

In response to the user's request, the components shown in block 330 appear. The user receives a new “cloned” avatar 350 that is controlled by the AI system to interact with the malevolent user 320 and the user's avatar 350 is made invisible to other users in the first area of the multiverse environment, most notably, invisible to malevolent user 320. The system, using AI, operates avatar 340 so that the malevolent user of avatar 320 is unaware that the user has opted to escape from the situation. The user now controls invisible avatar 350 and can move the avatar away from avatar 320 into a second area of the multiverse environment.

Blocks 360 and 380 depict what happens after the user moves his avatar (avatar 350) to a second area in the multiverse environment and makes his avatar visible to other users in the multiverse environment. Block 360 shows the second area of the multiverse environment which is the area to which the user moved his “invisible” avatar after requesting an “escape.” Block 360 depicts the user (avatar 370) now being visible and interacting with other users, such as the friendly user that controls avatar 375. Meanwhile, at the same time, malevolent user 320 continues to interact with cloned avatar 340 that is being controlled by the system (AI controlled). In one embodiment, cloned avatar 340 uses trained models of the user's verbal and non-verbal actions so that the AI can operate cloned avatar 340 to appear essentially the same as it behaved and spoke prior to the user “escaping” the uncomfortable situation. In one embodiment, cloned avatar 340 disappears after some period of time with such period of time being at least sufficient for the user of avatar 350 to escape and move the avatar to second area depicted in block 360.

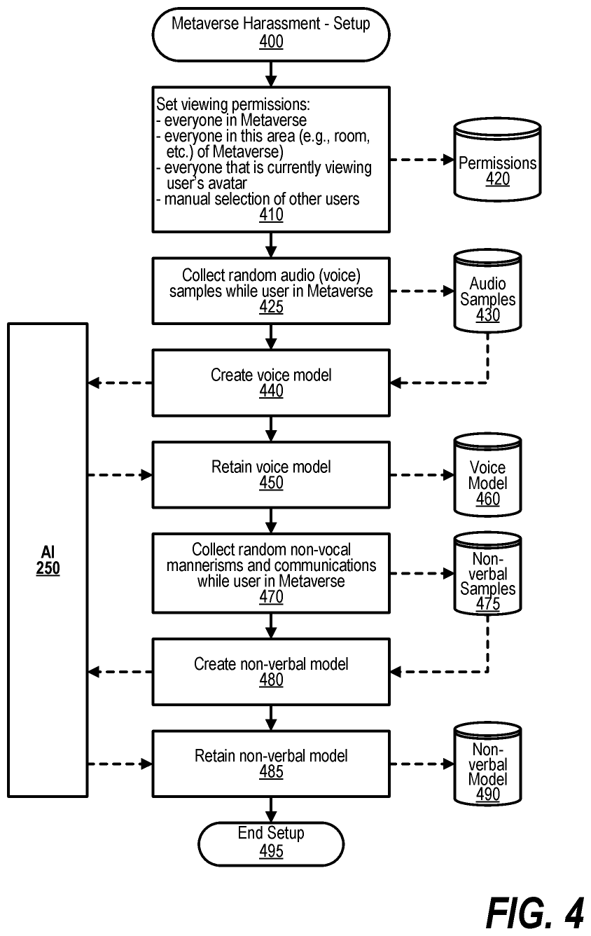

FIG. 4 is a flowchart depicting steps taken to set up a metaverse harassment prevention environment. FIG. 4 processing commences at 400 and shows the steps taken by a process that is performed to set up a metaverse harassment configuration for a user. At step 410, the process sets viewing permissions indicating which users are prevented from seeing the user's avatar when the user activates the escape function. Options can include can everyone in the metaverse, everyone in this area (e.g., room, etc.) of the metaverse, everyone that is currently viewing the user's avatar, a manual selection of the avatars by the user, etc. These permissions are stored in data store 420.

At step 425, the process collects random audio (voice) samples while the user is using metaverse, such as while the user is speaking into a microphone with the audible voice being set to other users in the metaverse to provide vocalizations corresponding to the user's avatar. These audio samples are stored in data store 430. At step 440, the process creates an artificial intelligence (AI) voice model that is used by AI system 250 to provide vocalizations to a user's cloned avatar after the user has activated the escape function.

At step 450, the process retains the user's voice model in data store 460. At step 470, the process collects random non-vocal mannerisms and non-verbal communications while the user is controlling their avatar in the metaverse. These non-verbal samples are stored in data store 475. At step 480, the process creates an AI non-verbal model that is used by AI system 250 to provide non-verbal communications performed by the user's cloned avatar after the user has activated the escape function. At step 485, the process retains non-verbal model in data store 490. FIG. 4 processing thereafter ends at 495.

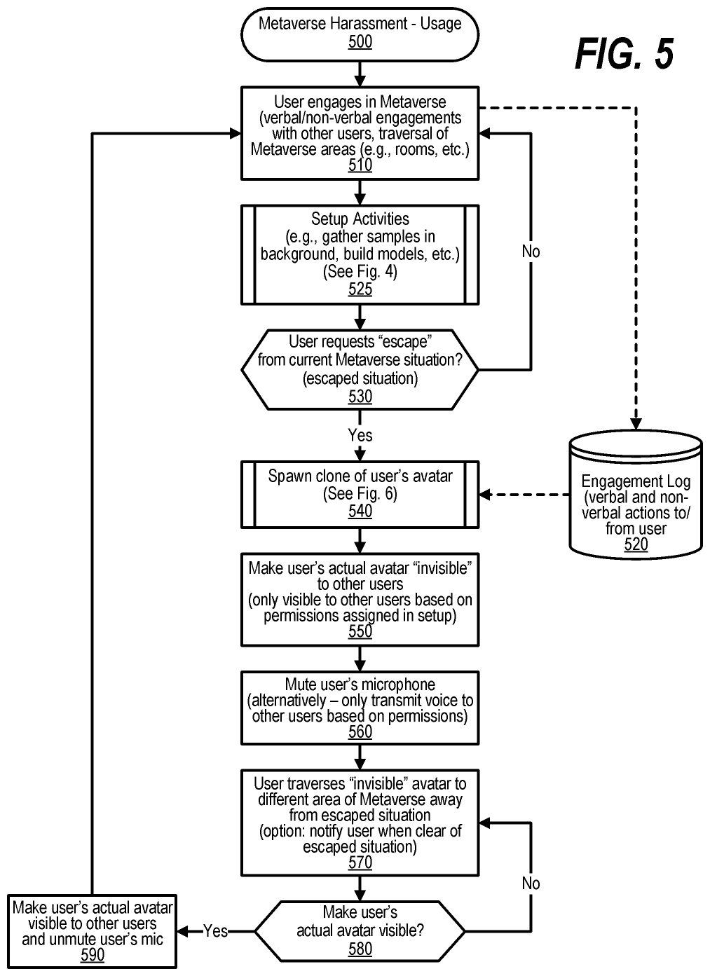

FIG. 5 is a flowchart depicting steps taken to allow a user to escape from a harassing situation in a metaverse environment. FIG. 5 processing commences at 500 and shows the steps taken by a process that depicts usage of a metaverse harassment prevention process. At step 510, the process facilitates user engagement in a metaverse hosted on a virtual reality website. In the metaverse environment, the user is represented by an avatar that can engage with other users' avatars through verbal and non-verbal communications and travel and traversal various metaverse areas (e.g., rooms, etc.). The engagements of the user's avatar with the multiverse environment are recorded in data store 520. At predefined process 525, the process performs the Setup Activities (e.g., gather samples in background, build verbal and non-verbal models, etc.) routine (see FIG. 4 and corresponding text for processing details).

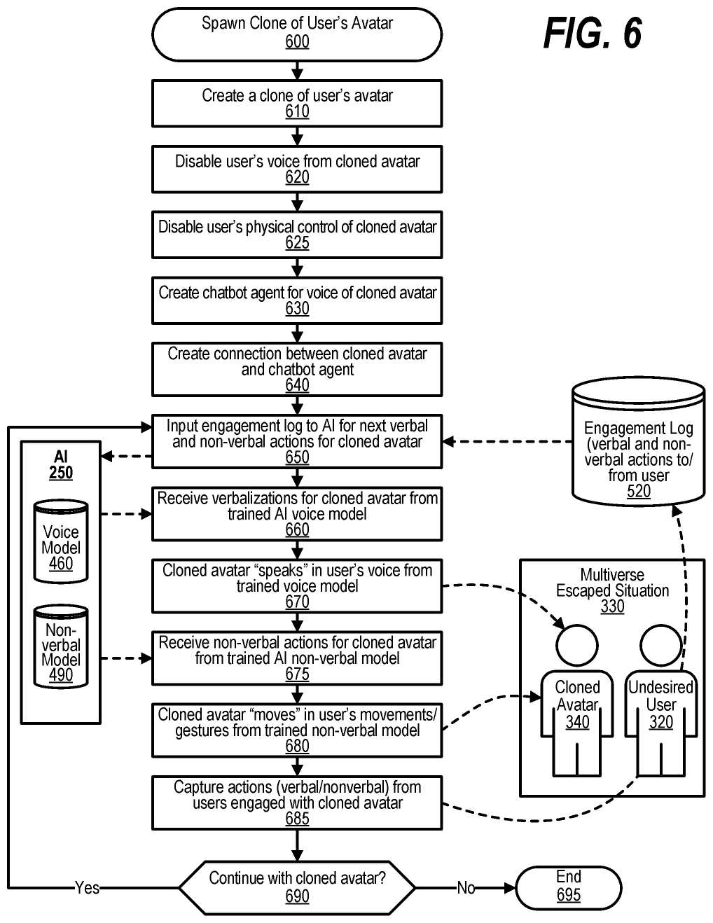

The process determines as to whether the user has requested to “escape” from a current metaverse situation due to harassment or other uncomfortable situation caused by one or more other users in the metaverse with avatars that are in proximity to the user's avatar (decision 530). If user requests an “escape” from a current metaverse situation, then decision 530 branches to the ‘yes’ branch which performs steps 540 through 590 allowing the user to escape from the uncomfortable metaverse situation. On the other hand, if the user does not request an “escape,” then processing loops back to step 510 to continue the user's engagement with the metaverse environment. Steps 540 through 590 are performed when the user requests to escape from the user's current metaverse situation. At predefined process 540, the process performs the Spawn Clone of User's Avatar routine (see FIG. 6 and corresponding text for processing details).

At step 550, the process makes the user's actual avatar “invisible” to other users so that the user's avatar is only visible to other users based on permissions assigned in the setup process. To achieve the objective of rendering a user's actual avatar “invisible” to others while allowing visibility based on permissions assigned during setup, a multifaceted technical approach is required. First, it involves establishing a robust user profile management system that incorporates user avatars. Second, a comprehensive permission system is developed, categorizing users into distinct roles and defining permissions governing avatar visibility. Users are then granted the flexibility to configure their avatar's visibility settings, choosing between predefined options like public, private, or custom, as shown in FIG. 4.

The technical implementation further necessitates backend storage for secure avatar storage and efficient access control mechanisms. These mechanisms enforce visibility rules rigorously, ensuring that only users with the requisite permissions can access avatars based on the owner's visibility settings. The user interface is also updated to reflect these settings, displaying avatars or placeholders as per the viewer's permissions and the owner's visibility preferences.

At step 560, the process mutes the user's microphone. In an alternative embodiment, the microphone is not muted but the user's vocalizations are only sent to other users, such as friends, based on the user's configured permissions. At step 570, the process allows the user to traverse, or move, the user's “invisible” avatar to a different area of the metaverse environment that is virtually distant from the escaped situation. In one embodiment, the system notifies the user when the user's avatar is clear of the escaped situation and the other avatars that caused the uncomfortable situation. The process determines as whether to make the user's actual avatar visible once again once the user's actual avatar is safely away from the uncomfortable situation (decision 580). If the determination is to make the user's avatar visible, then decision 580 branches to the ‘yes’ branch. On the other hand, the determination is to have the user's avatar remain invisible, then decision 580 branches to the ‘no’ branch which loops back to step 570 to allow the user to continue to move his avatar to a save virtual area away from the first area that the user found to be uncomfortable. This looping continues until the user's avatar is in a safe second area that is virtually distant from the first area from which the user escaped. When the user has reached a safe area, at step 590, the process makes the user's actual avatar visible once again so that other users with nearby avatars can see the user's avatar and the process unmutes the user's microphone (if muted) so that the user can converse with the users that have nearby avatars. Processing then loops back to step 510 with the user continuing to engage in the multiverse environment.

FIG. 6 is a flowchart depicting steps taken when cloning a user's avatar to allow the cloned avatar to escape from harassing users in an undetected fashion. FIG. 6 illustrates a sequential process that commences at step 600 and delineates the various stages involved in creating and operating a cloned avatar with specific functionalities.

At step 610, the process initiates by creating a clone of the user's avatar. Subsequently, at step 620, it disables the user's voice from being associated with the cloned avatar, ensuring that the clone has its own voice that is controlled by AI 250. Simultaneously, at step 625, the process disables the user's physical control over the cloned avatar, allowing it to operate autonomously by AI 250.

To enhance the cloned avatar's capabilities, at step 630, the process creates a chatbot agent designed to manage the voice interactions of the cloned avatar. It then proceeds to establish a connection between the cloned avatar and the chatbot agent at step 640.

To impart more intelligence and responsiveness to the cloned avatar, at step 650, the process inputs engagement log data from data store 520 to AI system 250. This AI system analyzes the log data and determines the next verbal and non-verbal actions for the cloned avatar.

Subsequently, at step 660, the process receives verbalizations for the cloned avatar from a trained AI voice model. The cloned avatar, now equipped with its own voice, “speaks” in the user's voice using the trained voice model 460 at step 670. Additionally, at step 675, the process receives instructions for non-verbal actions for the cloned avatar using a trained AI non-verbal model 490. The cloned avatar then “moves” in ways that mimic the user's movements and gestures as per the trained non-verbal model at step 680.

Throughout this process, the system captures actions, both verbal and non-verbal, from users engaged with the cloned avatar at step 685. The culmination of these actions is used to determine whether the operation of the cloned avatar should continue, as indicated by decision 690. If the decision is to continue, the process loops back to step 650, where the AI system analyzes engagement logs for the next set of actions. This looping process continues until a point is reached where the cloned avatar is no longer required to operate. At this juncture, decision 690 branches to the ‘no’ branch, exiting the loop and concluding the process.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, implemented by a processor coupled to a memory, comprising:
displaying a plurality of avatars locating in a first virtual area that is provided by a virtual reality (VR) platform, wherein the avatars are visible to a first plurality of users with avatars in the first virtual area, and wherein each of the users controls one of the displayed avatars;
receiving a request from a selected user from the plurality of users, wherein the selected user controls a first avatar from the plurality of avatars;
in response to the request:
cloning the first avatar creating a second avatar, wherein the second avatar is visible to the selected user and invisible to one or more of the plurality of users, and wherein the selected user controls the second avatar; and
automatically controlling the first avatar using artificial intelligence (AI), wherein the selected user no longer controls the first avatar.

2. The method of claim 1 wherein the automatic controlling further comprises:
emitting vocalizations corresponding to the first avatar using a trained voice model of the selected user utilized by the AI.

3. The method of claim 1 further comprising:
moving the first avatar using a trained non-verbal model that is utilized by the AI.

4. The method of claim 1 further comprising:
after a period of time subsequent to the cloning, deleting the first avatar, wherein the first avatar is no longer visible to the first plurality of users.

5. The method of claim 1 further comprising:
moving, based on one or more actions received from the selected user, the second avatar to a second virtual area provided by the VR platform, wherein the second virtual area is virtually distant from the common virtual area so that first plurality of users with avatars in the first virtual area cannot view the second avatar in the second virtual area; and
visualizing the second avatar so that the second avatar is no longer invisible to a second plurality of users with avatars in the second virtual area.

6. The method of claim 5 further comprising:
receiving, at a microphone, a plurality of vocalizations from the selected user;
sending the received vocalizations to the first plurality of users prior to the cloning;
inhibiting the sending of the received vocalizations to the first plurality of users after the cloning; and
training an artificial intelligence voice model corresponding to the selected user using the received vocalizations.

7. The method of claim 6 further comprising:
after the visualizing of the second avatar, sending the received vocalizations to the second plurality of users.

8. An information handling system comprising:
one or more processors;
a memory coupled to at least one of the processors; and
a set of instructions stored in the memory and executed by at least one of the processors to perform actions comprising:
displaying a plurality of avatars locating in a first virtual area that is provided by a virtual reality (VR) platform, wherein the avatars are visible to a first plurality of users with avatars in the first virtual area, and wherein each of the users controls one of the displayed avatars;
receiving a request from a selected user from the plurality of users, wherein the selected user controls a first avatar from the plurality of avatars;
in response to the request:
cloning the first avatar creating a second avatar, wherein the second avatar is visible to the selected user and invisible to one or more of the plurality of users, and wherein the selected user controls the second avatar; and
automatically controlling the first avatar using artificial intelligence (AI), wherein the selected user no longer controls the first avatar.

9. The information handling system of claim 8 wherein the automatic controlling further comprises:
emitting vocalizations corresponding to the first avatar using a trained voice model of the selected user utilized by the AI.

10. The information handling system of claim 8 wherein the actions further comprise:
moving the first avatar using a trained non-verbal model that is utilized by the AI.

11. The information handling system of claim 8 wherein the actions further comprise:
after a period of time subsequent to the cloning, deleting the first avatar, wherein the first avatar is no longer visible to the first plurality of users.

12. The information handling system of claim 8 wherein the actions further comprise:
moving, based on one or more actions received from the selected user, the second avatar to a second virtual area provided by the VR platform, wherein the second virtual area is virtually distant from the common virtual area so that first plurality of users with avatars in the first virtual area cannot view the second avatar in the second virtual area; and
visualizing the second avatar so that the second avatar is no longer invisible to a second plurality of users with avatars in the second virtual area.

13. The information handling system of claim 12 wherein the actions further comprise:
receiving, at a microphone, a plurality of vocalizations from the selected user;
sending the received vocalizations to the first plurality of users prior to the cloning;
inhibiting the sending of the received vocalizations to the first plurality of users after the cloning; and
training an artificial intelligence voice model corresponding to the selected user using the received vocalizations.

14. The information handling system of claim 13 wherein the actions further comprise:
after the visualizing of the second avatar, sending the received vocalizations to the second plurality of users.

15. A computer program product comprising:
a computer readable storage medium comprising a set of computer instructions that, when executed by a processor, are effective to perform actions comprising:
displaying a plurality of avatars locating in a first virtual area that is provided by a virtual reality (VR) platform, wherein the avatars are visible to a first plurality of users with avatars in the first virtual area, and wherein each of the users controls one of the displayed avatars;
receiving a request from a selected user from the plurality of users, wherein the selected user controls a first avatar from the plurality of avatars;
in response to the request:
cloning the first avatar creating a second avatar, wherein the second avatar is visible to the selected user and invisible to one or more of the plurality of users, and wherein the selected user controls the second avatar; and
automatically controlling the first avatar using artificial intelligence (AI), wherein the selected user no longer controls the first avatar.

16. The computer program product of claim 15 wherein the automatic controlling further comprises:
emitting vocalizations corresponding to the first avatar using a trained voice model of the selected user utilized by the AI.

17. The computer program product of claim 15 wherein the actions further comprise:
moving the first avatar using a trained non-verbal model that is utilized by the AI.

18. The computer program product of claim 15 wherein the actions further comprise:
after a period of time subsequent to the cloning, deleting the first avatar, wherein the first avatar is no longer visible to the first plurality of users.

19. The computer program product of claim 15 wherein the actions further comprise:
moving, based on one or more actions received from the selected user, the second avatar to a second virtual area provided by the VR platform, wherein the second virtual area is virtually distant from the common virtual area so that first plurality of users with avatars in the first virtual area cannot view the second avatar in the second virtual area; and
visualizing the second avatar so that the second avatar is no longer invisible to a second plurality of users with avatars in the second virtual area.

20. The computer program product of claim 19 wherein the actions further comprise:
receiving, at a microphone, a plurality of vocalizations from the selected user;
sending the received vocalizations to the first plurality of users prior to the cloning;
inhibiting the sending of the received vocalizations to the first plurality of users after the cloning;
training an artificial intelligence voice model corresponding to the selected user using the received vocalizations; and
after the visualizing of the second avatar, sending the received vocalizations to the second plurality of users.
